(19) United States
(12) Patent Application Publication
(10) Pub. No.: US 2025/0093690 A1
(43) Pub. Date: Mar. 20, 2025

(54) SYSTEM OF TUNABLE METASURFACE

(71) Applicant: SHENZHEN METALENX TECHNOLOGY CO.,LTD, Shenzhen (CN)

(72) Inventors: Chenglong HAO, Shenzhen (CN); Fengze TAN, Shenzhen (CN); Rui ZHU, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/969,204

(22) Filed: Dec. 4, 2024

Related U.S. Application Data
(63) Continuation of application No. PCT/CN2023/097980, filed on Jun. 2, 2023.

(30) Foreign Application Priority Data
Jun. 14, 2022 (CN) 202210668436.2

(51) Int. Cl. G02F 1/01; G02F 1/03

(52) U.S. Cl. CPC G02F 1/0147; G02F 1/0305

(57) ABSTRACT

A system of a tunable metasurface is provided, and the system of a tunable metasurface includes: a wavefront modulator, an optical focusing device, a metasurface; the metasurface includes a plurality of nanostructures made of a phase change material, and a phase change state of the phase change material comprises a crystalline state and an amorphous state; the wavefront modulator is set on a side of the optical focusing device that is far away from the metasurface; and the wavefront modulator is used to modulate a wavefront aberration of incident control lights and emit the control lights after wavefront modulated towards the optical focusing device; the optical focusing device is used to focus wavefront-modulated control lights to form a plurality of focal points; the metasurface is set on a focal plane formed by the plurality of focal points.

### CROSS-REFERENCE TO RELATED APPLICATION

This application is a continuation of International Patent Application of PCT application serial No. PCT/CN2023/097980, filed on Jun. 2, 2023, which claims the benefit of priority from China Application No. 202210668436.2, filed on Jun. 14, 2022. The entirety of each of the above-mentioned patent applications is hereby incorporated by reference herein and made a part of this specification.

### BACKGROUND

### Technical Field

The present disclosure relates to the field of an optical element, in particular to a system of a tunable metasurface.

### Description of Related Art

The optical performance of the metasurface is mainly determined by two factors: (1) the geometry and size of the structural unit; (2) and the dielectric constant of the material. When the metasurface is prepared, the geometry and size of the structure are usually difficult to change, so the dielectric constant of the material can be changed to realize the modulation or reconstruction of the optical performance of the metasurface.

The phase change material can be converted between crystalline state and amorphous state, and phase change material of different states can achieve different modulation effects. For example, beams are incident into the phase change material, the outgoing left-circularly polarized lights are deflected to the right when the phase change material is at the amorphous state. When the phase change material is in the crystalline state, the outgoing left-circularly polarized lights are deflected to the left to achieve binary modulation. In addition, some schemes use the characteristics of the phase change material can be a partially crystalline state, which makes the gradual change process of conversion between the amorphous state and the crystalline state, so as to realize the phase can be continuously modulated.

The phase change material switches between the crystalline state and amorphous state in the prior art by electric control. For example, electrodes can be set on the upper and lower sides of the phase change material, and the phase change material can be heated by electric control to achieve adjusted effect of a tunable metasurface. However, on the one hand, all electric controls need to solve the problem of wiring. When there are many pixels (such as, the number of pixels is greater than 1 million), the wiring needs to be pulled quite far, so that the size of the pixel can not be too large. On the other hand, due to the limitation of the electronic wiring process, it is an extremely challenging for a single electrode to reach the scale of 100 nm, thus limiting the pixel size and the number of pixels of the tunable metasurface.

### SUMMARY

In order to solve the problem, a system of a tunable metasurface is provided.

In the first aspect of the present application, a system of a tunable metasurface is provided. The system of a tunable metasurface includes: a wavefront modulator, an optical focusing device, a metasurface;
the metasurface includes a plurality of nanostructures made of a phase change material, and a phase change state of the phase change material comprises a crystalline state and an amorphous state;
the wavefront modulator is set on a side of the optical focusing device that is far away from the metasurface; and the wavefront modulator is used to modulate a wavefront aberration of incident control lights and emit the control lights after wavefront modulated towards the optical focusing device;
the optical focusing device is used to focus wavefront-modulated control lights to form a plurality of focal points;
the metasurface is set on a focal plane formed by the plurality of focal points, and at least some nanostructures correspond to the positions of the plurality of focal points; the metasurface is used to modulate a phase of an incident working light, and an optical path of the working light will not overlap with the wavefront modulator and the optical focusing device.

In one embodiment, the metasurface includes a transparent substrate, and the plurality of nanostructures are set on one side of the transparent substrate;
one end of each nanostructure that is closer to the transparent substrate corresponds to the position of the focal point.

In one embodiment, the metasurface includes a metal reflective layer;
the metal reflective layer is set between the nanostructures and the transparent substrate, and a side of the reflective layer that is closer to the nanostructures is a reflective side of the metal reflective layer.

In one embodiment, the wavefront modulator, the optical focusing device is set on a side of the metal reflective layer that is away from the nanostructures.

In one embodiment, the metasurface includes a plurality of photo-thermal conversion structures;
the plurality of photo-thermal conversion structures are set on a side of the transparent substrate that is closer to the nanostructures, and the positions of the nanostructures correspond to the photo-thermal conversion structures one to one;
the photo-thermal conversion structures are used to convert the light energy of the incident control lights into thermal energy.

In one embodiment, the metasurface includes a matching dielectric layer;
the matching dielectric layer is set between the nanostructures and the transparent substrate, and the matching dielectric layer is contacted to the nanostructures.

In one embodiment, the metasurface includes a filler material, and the filler material is transparent at a working waveband;
and the filler material is filled between the nanostructures, and a difference between a refractive index of the filler material and a refractive index of the nanostructures is greater than or equal to 0.5.

In one embodiment, a numerical aperture of the optical focusing device is greater than a pre-set threshold;
when the numerical aperture of the optical focusing device is equal to the pre-set threshold, the size of the focal points of the optical focusing device formed on the metasurface is greater than or equal to a period of the nanostructures.

In one embodiment, the pre-set threshold is greater than or equal to 0.6.

In one embodiment, a wavefront aberration of the optical focusing device is less than 0.32, and λ is a wavelength of the control lights.

In one embodiment, the optical focusing device includes a lens group;
the lens group consists of a plurality of lenses.

In one embodiment, the lens group consists of at least one lens and at least one metalens.

In one embodiment, the lens group consists of a plurality of metalenses.

In one embodiment, the optical focusing device is an on-axis multi-focal focusing device.

In one embodiment, the optical focusing device is an off-axis multi-focal focusing device.

In one embodiment, a wavelength of the control lights is different from a wavelength of the working lights.

In one embodiment, the control lights are parallel.

In one embodiment, the phase change material comprises at least one material of germanium antimony telluride, germanium telluride, antimony telluride, silver antimony telluride.

In one embodiment, the wavefront modulator is set on the position of entrance pupil of the optical focusing device.

In the present application, a wavefront modulator and an optical focusing device are used to generate multiple controllable focal points at the position of the metasurface. The positions of the focal points correspond to the positions of the nanostructures made of phase change materials, thereby enabling an independent optical control of the nanostructures. The phase change states of each of the nanostructures are changed independently by a method of the optical control, thus achieving pixel-level phase change. The system of the tunable metasurface controls the phase change state of the metasurface by the optical control without electrical wiring, which avoids the limitations of wiring processes. Furthermore, the wavefront modulator and the optical focusing device can form hundred-nanometer focal points, which makes the focal points able to apply to a smaller size or a larger number of pixels. In this way, it allows for designing the number and size of pixels of the metasurface based on actual requirements, thus enabling broader applications.

In order to make the above objectives, features and advantages of the application more obvious and understandable, the better embodiments are given below and detailed in accordance with the attached drawings.

### BRIEF DESCRIPTION OF THE DRAWINGS

In order to explain embodiments of the present disclosure or the prior art more clearly, drawings used in the description of the embodiments, or the prior art will be briefly explained below. Obviously, the following drawings are merely for exemplary and explanatory purposes. It is understood by those skilled in the art that without paying any creative efforts, other drawings are available based on the following drawings.

FIG. 1 shows a structural schematic diagram of a system of tunable metasurface provided by an embodiment of the present application;

FIG. 2 shows another structural schematic diagram of a system of a tunable metasurface provided by an embodiment of the present application;

FIG. 3A shows a first structural schematic diagram of the first optical focusing device in a system of a tunable metasurface provided by an embodiment of the present application;

FIG. 3B shows a first structural schematic diagram of the first optical focusing device in a system of a tunable metasurface provided by an embodiment of the present application;

FIG. 3C shows a first structural schematic diagram of the first optical focusing device in a system of a tunable metasurface provided by an embodiment of the present application;

FIG. 4 shows another schematic diagram of a system of a tunable metasurface provided by an embodiment of the present application;

FIG. 5A shows a first structural schematic diagram of the transmissive metasurface provided by an embodiment of the present application;

FIG. 5B shows a second structural diagram of the transmissive metasurface provided by an embodiment of the present application;

FIG. 6A shows a third structural diagram of the transmissive metasurface provided by the embodiment of the present application;

FIG. 6B shows a fourth structural diagram of the transmissive structure provided by the embodiment of the present application;

FIG. 7A shows a fifth structural schematic diagram of the transmissive metasurface provided by an embodiment of the present application;

FIG. 7B shows a sixth structural schematic diagram of the transmissive metasurface provided by the embodiment of the present application;

FIG. 8A shows a first structural schematic diagram of the reflective metasurface provided by the embodiment of the present application;

FIG. 8B shows a second structural schematic diagram of the reflective metasurface provided by an embodiment of the present application;

FIG. 9A shows a third structural schematic diagram of the reflective metasurface provided by the embodiment of the present application;

FIG. 9B shows a fourth structural schematic diagram of the reflective metasurface provided by the embodiment of the present application;

FIG. 10A shows a fifth structural schematic diagram of the reflective metasurface provided by the embodiment of the present application;

FIG. 10B shows a sixth structural schematic diagram of the reflective metasurface provided by the embodiment of the present application;

FIG. 11 shows a distribution of the focal points and an entrance pupil phase diagram provided by an embodiment of the application;

FIG. 12 shows another distribution of the focal points and an entrance pupil phase diagram provided by an embodiment of the application.

### DESCRIPTION OF THE EMBODIMENTS

In the description of the present application, It needs to be understood that the terms of “center”, “longitudinal”, “transverse”, “length”, “width”, “, “thickness”, “, “up”, “down”, “““front”, “after”, “left”, “right”, “vertical”, “, “level”, “, “top”, “, “bottom”, “inside”, “, “outside”, “clockwise”, “counterclockwise” indicate the orientation or position relationship based on the orientation or position shown in the attached figure, Only to facilitate the description of the present application and to simplify the description, Rather than indicating or implying that the device or element must have a specific orientation, be constructed and operate in a specific orientation, thus it cannot be understood as a limitation of the present application.

Moreover, the terms “first”, “second” are used only for descriptive purposes and cannot be understood as indicating or implying relative importance or implicitly indicating the number of technical characteristics indicated. Thus, the features defining the first or second may explicitly or implicitly include one or more features. In the description of the application, the meaning of “multiple” is two or more, unless otherwise specified and specific.

In the present application, unless otherwise clearly defined and defined, the terms “installed”, “connected”, or “fixed” should be generalized, such as fixed or removable, mechanical or electrical, directly or indirectly through an intermediate medium, or the internal connection of the two elements. For those skilled in the art, the specific meaning of the above term in the application may be understood in the light of specific circumstances.

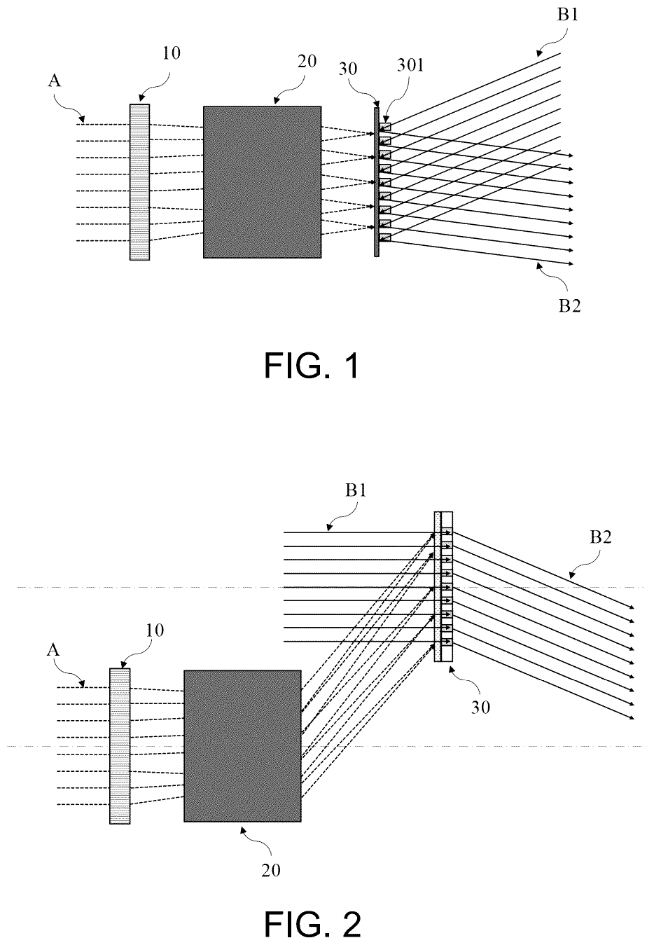

A system of tunable metasurface is provided by the present application, and the system can realize tunable phase of the metasurface by the optical control. As shown in FIG. 1, the system of tunable metasurface includes a wavefront modulator, an optical focusing device, a metasurface. The metasurface includes a plurality of nanostructures made of a phase change material, and a phase change state of the phase change material comprises a crystalline state and an amorphous state.

The wavefront modulator is set on a side of the optical focusing device that is far away from the metasurface. The optical focusing device is set between the wavefront modulator and the metasurface. To control the wavefront modulator 10 easily, optionally, the wavefront modulator 10 is set on the position of entrance pupil of the optical focusing device 20. The wavefront modulator is used to modulate a wavefront aberration of a plurality of incident control lights and the wavefront modulator is used to emit the wavefront-modulated control lights towards the optical focusing device; the optical focusing device is used to focus the wavefront-modulated control lights to form a plurality of focal points; the metasurface is set on a focal plane formed by the plurality of focal points, and at least some nanostructures correspond to the positions of the plurality of focal points; the metasurface is used to modulate a phase of an incident working light, and the optical path of the working light will not overlap with the wavefront modulator and the optical focusing device. The nanostructures 301 are full-dielectric structures, and the nanostructures 301 have high transmittance at the working waveband (such as visible lights). The nanostructures 301 are arranged in a period array of a regular hexagon, square, or fan shape. For example, the nanostructures 301 can be set on the center and/or vertice of a period.

In the present application, for the nanostructures made of the phase change material, the lattice of the phase change material will change under external excitation such as laser, which will change the dielectric constant significantly. In this way, the state of the phase change material changes, and the tunable phase is realized. In the present application, the system of tunable metasurface enables phase control of the metasurface 301 by controlling the light and exciting the nanostructure 301. Specifically, controlling the light and exciting the nanostructure 301 is realized by focusing the control lights A on the corresponding nanostructures 301. And the present application uses the wavefront modulator 10 and the optical focusing device 20 to focus the control lights A on the nanostructures 301.

Specifically, the wavefront modulator 10 (also called as a wavefront regulator) is used to change the phase of lights (for example, the changing phase is realized by the birefringent effect), so as to change and control the wavefront of lights. As shown in FIG. 1, the control lights A are incident to the wavefront modulator 10, and the wavefront modulator 10 enables to modulate the wavefront of the control lights A, and the wavefront modulated control lights A are transmitted to the optical focusing device 20. Optionally, the control lights A are parallel lights. As shown in FIG. 1, the wavefront modulator 10 may be transmissive, or may be reflective, which will not be limited here. For example, the wavefront modulator 10 may be an LCSLM, DMD or a spatial optical modulator made of the tunable metasurface, etc.

The optical focusing device 20 enables to focus the wavefront-modulated control lights A to form a plurality of focal points. Specifically, the wavefront modulator is set on the position of an entrance pupil of the optical focusing device 20, and the optical focusing device 20 can generate a plurality of focal points. The internals of the focal points are at nanometer scale or micrometer scale, for example, the internals of the focal points are at hundred-nanometer scale to make different focal points correspond to different nanostructures 301. In this way, the control lights A will be focused on the nanostructures 301 to modulate the phase of different nanostructures 301 independently, so as to make the metasurface 30 realize a pixel-level phase change. And the phase relationship between the positions of the adjustable focal points and the position of the entrance pupil is as follows:

$$φ ( x , z ) = {\sum }_{i = 1} exp [ - ik ( {a}_{i} x + {b}_{i} z ) ]$$

x, z represent a coordinate axis of the optical focusing device at a pupil plane, and a lowest value and a highest value of x, z are determined by an entrance pupil aperture of the optical focusing device; k is a wave number, and the aᵢ and bᵢ are the coordinates of the focal points on the iₜₕ focal plane.

In the present application, the plurality of focal points can be generated by controlling the modulation effect of the wavefront modulator 10, and the plurality of focal points are located at the same plane which is called as focal plane. The metasurface 30 is set on the focal plane, so as to make the nanostructures 301 located at the focal points. For example, the generated focal points correspond to the nanostructures 301 of the metasurface 30 one to one. Moreover, the wavefront modulator 10 can control which focal points will be formed on positions of the nanostructures 301, thereby enabling the optical control of each nanostructure 301 to modulate the phases of each nanostructure 301.

The phase change material at different phase change states will have different modulation effects. The phase change state includes a crystalline state and an amorphous state, etc. For example, the phase change material of the nanostructures 301 may be germanium antimony telluride (Ge_{X}SB_{Y}TE_{Z}), gerium telluride (Ge_{X}TE_{Y}), antimony telluride (Sb_{X}TE_{Y}), silver antimony telluride (Ag_{X}SB_{Y}TE_{Z}). For example, the phase change material may be GST (Ge₂SB₂TE₅). In general, GST is at an amorphous state. After applying the laser excitation to GST, GST is heated and GST is converted to a crystalline state, thus realizing the rapid switching from the amorphous state to crystalline state. After the crystalline GST is heated beyond the melting point, it can be converted to an amorphous state again by rapid cooling. The entire cooling process can be completed within 10 ns, so as to realize a rapid conversion from the crystalline state to the amorphous state. If the nanostructures 301 are made of GST, the temperature of the nanostructures may be changed by focusing control lights A, so as to realize the rapid switching between the crystalline state and the amorphous state.

In the present application, the control lights A are used to apply the excitation to nanostructures 301, and the nanostructures 30 are used to modulate the phase of other lights. In the present application, the other lights that need to be modulated by the metasurface 30 are called as working lights and represented as working lights B. To avoid the working lights B being influenced by the wavefront modulator 10 and the optical focusing device 20, the wavefront modulator 10 and the optical focusing device 20 are set on the position except for the optical path of working lights B in the present application. That is, the optical path of working lights B will not overlap with the wavefront modulator 10 and the optical focusing device 20.

In the present application, the nanostructures 301 are made of the phase change material of the crystalline state or amorphous state, so that the phase modulation can be realized without changing the transmissive and reflective characteristics of the metasurface 30. That is, the metasurface is transmissive, or the metasurface is reflective all the time to easily set the position of the wavefront modulator 10 and the optical focusing device 20 and avoid overlapping with the optical path of the working lights B. When the metasurface 30 is reflective, the nanostructures 301 and the wavefront modulator 10 may be set on two sides of the metasurface, respectively, so that the nanostructures 301, and the wavefront modulator 10 are coaxial. For example, the metasurface 30 includes a plurality of metal reflective layers and a plurality of nanostructures; the wavefront modulator 10 and the optical focusing device 20 are set on one side of the metal reflective layer, the nanostructures are set on another side of the metal reflective layer which is called a reflective side; the working lights B are incident from the opposite side of the metal reflective layer to the metasurface 30.

For example, as shown in FIG. 1, if the metasurface 30 is a reflective metasurface used for reflecting the incident working lights B1, the reflected lights are called as B2. The wavefront modulator 10 and the optical focusing device 20 may be set on another side of the metasurface, and the wavefront modulator 10, the optical focusing device 20 and the metasurface 30 are coaxial. The optical focusing device 20 may be an on-axis multi-focal focusing device. In one embodiment, as shown FIG. 2, if the metasurface is a transmissive metasurface (such as a metalens), the metasurface 30 is used to modulate the phase of the working lights B1, and the modulated working lights B2 transmits the metasurface 30; the wavefront modulator 10 and the optical focusing device 20 may be set either side of the metasurface 30, as long as the wavefront modulator 10 and the optical focusing device 20 will not overlap with the working lights. In this situation, the optical focusing device 20 is not coaxial with the metasurface 30. The optical focusing device 20 may be an off-axis multi-focal focusing device to generate off-axis multiple focal points. Optionally, the control lights and the working lights have different wavelengths to avoid the control lights influencing the working lights.

A system of a tunable metasurface provided by the present application, the system of the tunable metasurface uses the wavefront modulator 10 and the optical focusing device 20 to generate multiple controllable focal points. The focal points correspond to the positions of the nanostructures 301 made of the phase change material, so as to realize independent-optical control of each nanostructure 301. The optical control for the nanostructures can change the phase change state of the nanostructures 301 to control the pixel-level phase change. The system of the tunable metasurface controls the phase change state of the metasurface 30 by optical control, which has no need for wiring and will not be limited by a wiring process. Moreover, the wavefront modulator 10 and the optical focusing device 20 can form hundred-nanometer focal points to be applied to smaller pixels or more pixels, and can be design the number and the size of the pixels based on the practical requirements to be applied to more applications (such as, all-solid-state lidar).

Optionally, the numerical aperture of the optical focusing device 20 is greater than the pre-set threshold. The size of the focal points formed by the optical focusing device 20 on the metasurface 30 is less than or equal to the period of the nanostructure 301. For example, the pre-set threshold is greater than or equal to 0.6. Optionally, the wavefront aberration of the optical focusing device 20 is less than 0.32, and λ is a wavelength of the control lights.

In the present application, the optical focusing device 20 has a larger numerical aperture and/or a smaller wavefront to generate focal points with hundred-nanometer intervals. A larger numerical aperture and a smaller wavefront aberration of the optical focusing device 20 ensures the smaller focal points and concentration energy, which is conducive to precise pixel-level modulation.

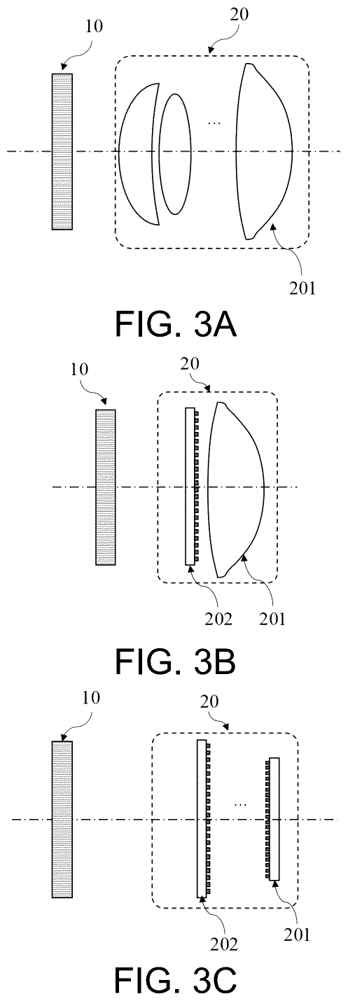

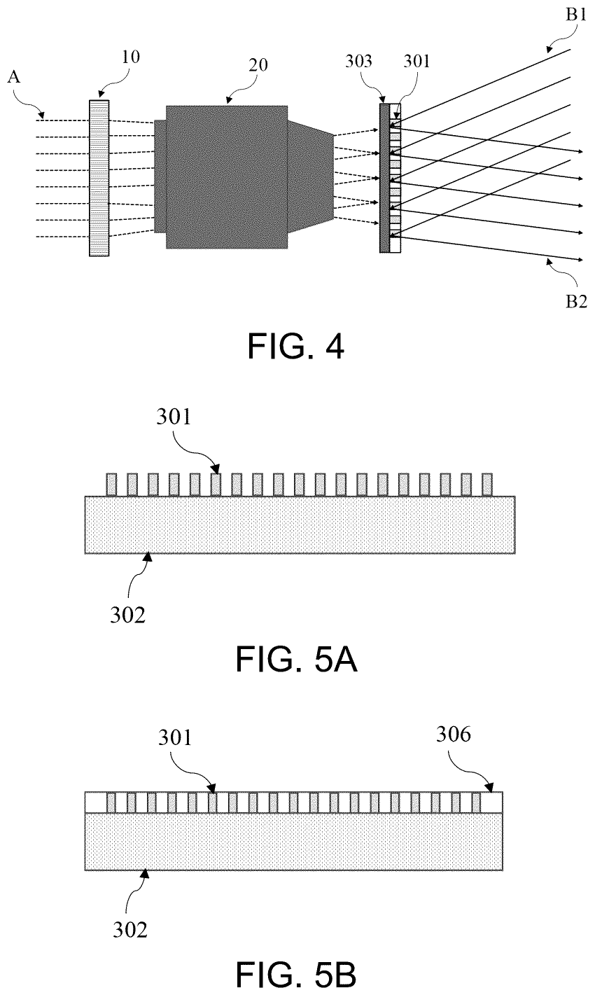

Optionally, the optical focusing device 20 includes a lens group. As shown from FIG. 3A to FIG. 3C, the lens group may consist of multiple lenses 201; or the lens group may consist of at least one lens 201 and at least one metalens 202; or the lens group may consist of the plurality of metalenses 202. And the lens 201 may be a kind of traditional reflective lens. For example, as shown in FIG. 4, the optical focusing device 20 may be a microscope objective; the correction of aberration of the microscope objective is better, which meets the requirements of the system of the tunable metasurface and forms the required focal points.

On the basis of any of the above embodiments, in addition to the nanostructure 301 made of the phase change material, the metasurface 30 further includes the transparent substrate 302 as shown in FIG. 5A; the plurality of nanostructures 301 is located on one side of the transparent substrate 302; and one end of each nanostructure 301 near the transparent substrate 302 corresponds to the position of the focal point.

In the present application, the transparent substrate 302 is transparent to allow the control lights A to pass through. The control lights A will form focal points at one end of each nanostructure 301 near the transparent substrate 302. Moreover, the end of each nanostructure 301 near the transparent substrate 302 corresponds to the position of the focal point.

In the embodiment, as shown in FIG. 5B, the metasurface 30 further includes a filler material 306, and the filler material 60 is transparent at the working waveband. The filler material 306 is filled between the nanostructures 301, and a difference of a refractive index of the filler material 306 and the refractive index of the nanostructures 301 is greater than or equal to 0.5. In the present embodiment, the filler material 306 is filled between the nanostructures 301 to protect the nanostructures 301. And a difference of a refractive index of the filler material 306 and the refractive index of the nanostructures 301 is greater than or equal to 0.5 to avoid the filler material 306 influencing light modulation effects. And the working wavefront refers to the waveband of the working lights B, that is, the filler material 306 is transparent at least at the waveband of working lights B.

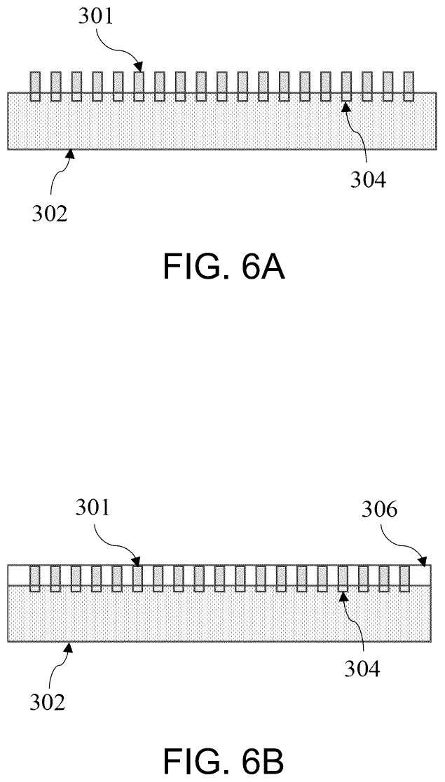

Optionally, as shown in FIG. 6A, the metasurface 30 also includes multiple photo-thermal conversion structures 304; these photo-thermal conversion structures 304 are located on the side of the transparent substrate 302 that is closest to the nanostructures 301, and the positions of the photo-thermal conversion structures 304 correspond with the positions of the nanostructures 301 one to one; the photo-thermal conversion structures 304 are used to convert the optical energy of the control lights A into thermal energy.

In this embodiment of the application, the photo-thermal conversion structures 304 are set on one side of the nanostructures 301 at corresponding positions, which allows the focal point on these photo-thermal conversion structures 304. These photo-thermal conversion structures 304 can quickly convert optical energy into thermal energy, thereby improving the speed and efficiency of phase change. For example, the photo-thermal conversion structures 304 may be made of photo-thermal sensitive materials.

Additionally, similar to the structure shown in FIG. 5B, the metasurface 30 can also include a filler material 306 as shown in FIG. 6B. The filler material 306 in FIG. 6B has the same function as the filler material 306 in the embodiment shown in FIG. 5B, which will not be repeated here.

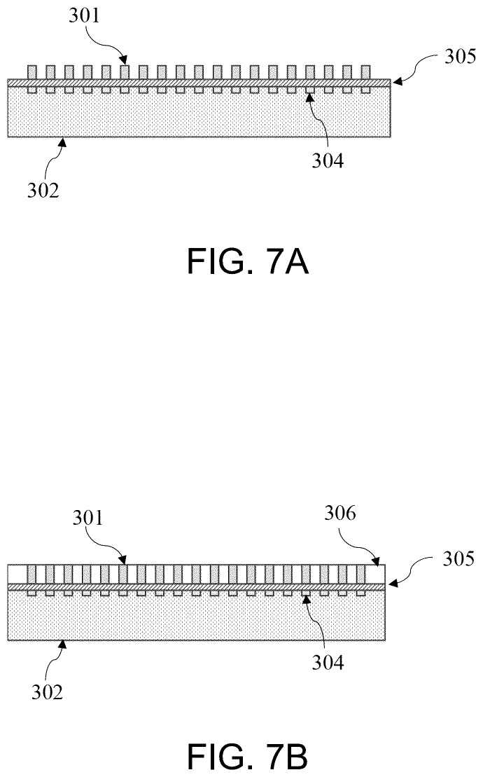

Optionally, as shown in FIG. 7A, the metasurface 30 also includes a dielectric matching layer 305; the dielectric matching layer 305 is located between the nanostructures 301 and the transparent substrate 302, and the dielectric matching layer 305 is contacted with the nanostructures 301.

In one embodiment of the application, the difference between the refractive index of the dielectric matching layer 305 and the refractive index (or effective refractive index) of the nanostructures 301 is less than or equal to a pre-set threshold. For example, the pre-set threshold may be 1 or 0.5, etc., so as to match the refractive index of the nanostructures 301 with the refractive index of the dielectric matching layer 305, thereby improving the transmittance of the nanostructures 301. For example, the thickness of the dielectric matching layer 305 may be 30 nm-1000 nm. The dielectric matching layer 305 is transparent at the working waveband, for example, the dielectric matching layer 305 can transmit the working lights B, etc. For example, the dielectric matching layer 305 may be made of quartz glass. Additionally, similar to the structure shown in FIG. 5B, the metasurface 30 can may include a filler material 306, as specifically shown in FIG. 7B.

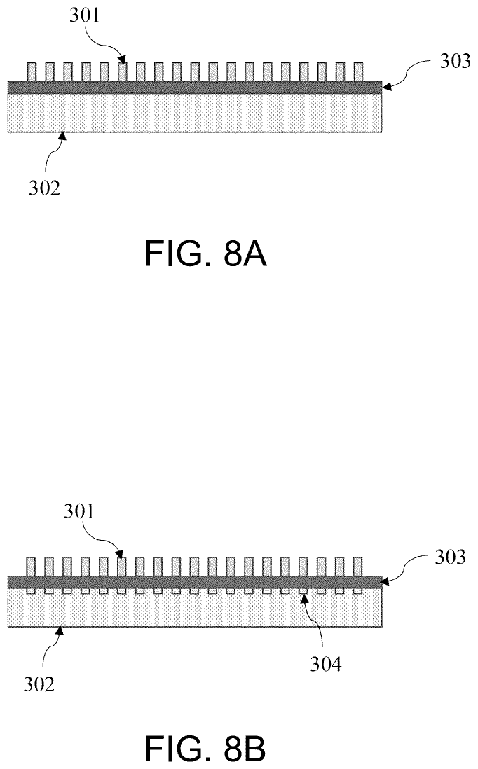

Optionally, as shown in FIG. 8A, the metasurface further includes the metal reflective layer 303; the metal refractive layer 303 is set between the nanostructures and the transparent substrate 302, and a reflective side of the metal reflective layer 303 is near one side of the nanostructures 301.

In the present embodiment, the metasurface 30 may be a reflective metasurface, and the metasurface 30 includes the metal reflective layer 303. The nanostructures 301 are set on the reflective layer of the metal reflective layer 303, so that the metasurface 30 can realize phase modulation by reflecting the incident lights. For example, the metal reflective layer 303 may be made of gold, silver, copper, aluminum, or an alloy thereof. The metal reflective layer 303 has a thickness of 100 nm to 100 μm, and optionally, the metasurface 30 may also include a filler material 306, as shown in FIG. 8B.

For example, when the metasurface 30 may be a reflective metasurface, as shown in FIG. 4, the nanostructure 301, the wavefront modulator 10 and the optical focusing device 20 may be set on either side of the metal reflective layer 303. That is, the wavefront modulator 10 and the optical focusing device 20 are set on one side of the metal reflective layer 303 away from the nanostructure 301, so that the optical focusing device 20 and the metasurface 30 can be coaxial to form focal points conveniently.

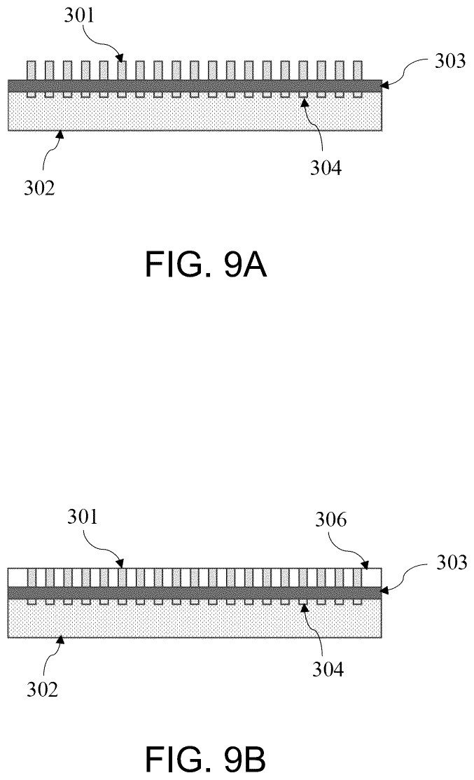

Optionally, as shown in FIG. 9A, the metasurface 30 may further include a plurality of photo-thermal conversion structures 304; the plurality of photo-thermal conversion structures 304 are set on one side of the transparent substrate 302 near the nanostructures 301, and the photo-thermal conversion structures 304 corresponds to the positions of the nanostructures 301 one to one; the photo-thermal conversion structures 304 are used to convert the optical energy of the control lights A into the thermal energy.

In this embodiment of the application, the photo-thermal conversion structures 304 are set on one side of the nanostructures 301 at corresponding positions, which allows the focal point focus on these photo-thermal conversion structures 304. These photo-thermal conversion structures 304 can quickly convert optical energy into thermal energy, thereby improving the speed and efficiency of phase change. For example, the photo-thermal conversion structures 304 are set between the transparent substrate 302 and the metal reflective layer 303, which makes the system of the tunable metasurface be a coaxial system. This allows the control lights A to be easily shined on the photo-thermal conversion structures 304 and form focal points. Additionally, the metasurface 30 can also include a filler material 306, as specifically shown in FIG. 9B.

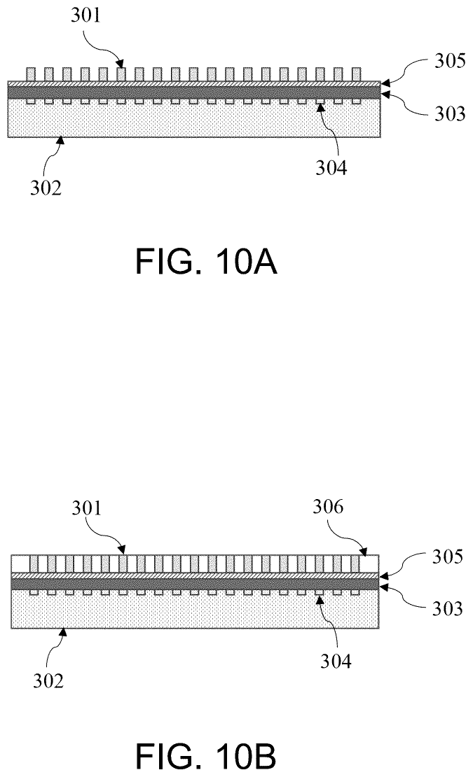

Optionally, as shown in FIG. 10A, the metasurface 30 further includes the dielectric matching layer 305; the dielectric matching layer 305 may be set between the nanostructures 301 and the transparent substrate 302, and the dielectric matching layer 305 is contacted to the nanostructures 301. As shown in FIG. 10A, the dielectric matching layer 305 may be set between the nanostructures 301 and the metal reflective layer 303.

In one embodiment of the application, the difference between the refractive index of the dielectric matching layer 305 and the refractive index (or effective refractive index) of the nanostructures 301 is less than or equal to a pre-set threshold. For example, the pre-set threshold may be 1 or 0.5, etc., so as to match the refractive index of the nanostructures 301 with the refractive index of the dielectric matching layer 305, thereby improving the transmittance of the nanostructures 301. For example, the thickness of the dielectric matching layer 305 may be 30 nm-1000 nm. The dielectric matching layer 305 is transparent at the working waveband, for example, the dielectric matching layer 305 can transmit the working lights B, etc. For example, the dielectric matching layer 305 may be made of quartz glass. Additionally, the metasurface structure 30 may further include a filler material 306, as specifically shown in FIG. 10B.

The working process of the system of the tunable metasurface is described in detail in one embodiment below.

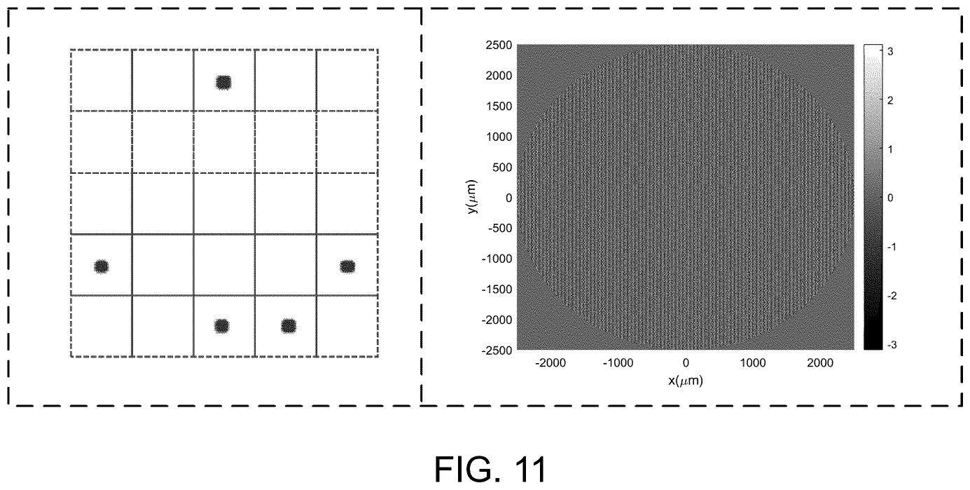

In the embodiment of the present application, the nanostructures 301 of the metasurface 30 are arranged in a period of 5×5, and each nanostructure 301 corresponds to one pixel, and the nanostructures 301 are arranged on the left diagram in FIG. 11. The period of nanostructure 301 is 1000 nm (that is, the edge length in the left diagram in FIG. 11 is 1000 nm), and the height of nanostructure 301 is 1500 nm. The optical focusing device 20 uses a microscopic objective with an entrance pupil diameter of 5 mm (5000 μm).

There are five focal points are formed on the surface of the metasurface 30 by controlling the modulation effect of the wavefront modulator 10. The distribution of five focal points can be seen on the left diagram of FIG. 11, which are indicated by the dots. At this time, the corresponding pupil phase diagram is shown on the right of FIG. 11.

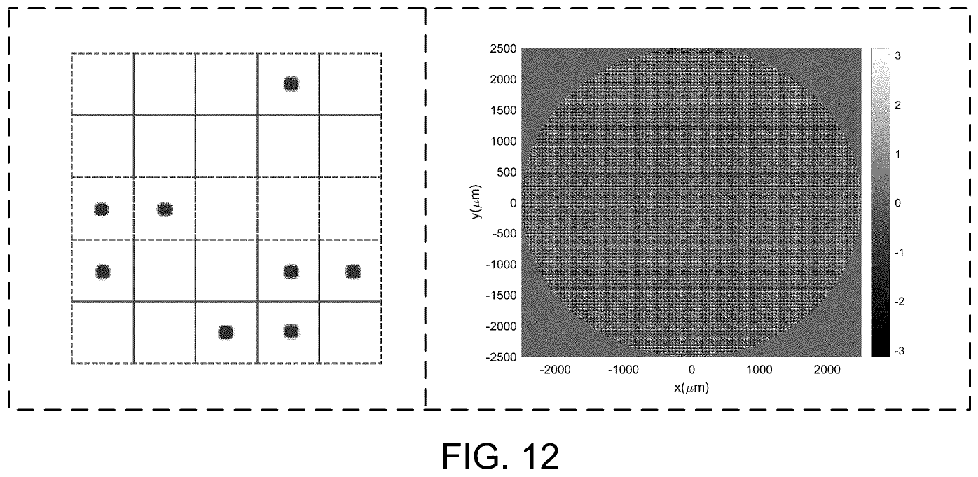

Furthermore, eight focal points are formed on the surface of the metasurface 30 by controlling the modulation effect of the wavefront modulator 10. The distribution of eight focal points can be seen in the left diagram of FIG. 12, which are indicated by the dots. At this time, the corresponding pupil phase diagram is shown in the right diagram of FIG. 12.

The above is only a specific embodiment of the embodiment of this application, but the scope of protection of the embodiment of this application is not limited to this, any person familiar with the scope of the change or substitution, should be covered within the protection scope of the embodiment of this application. Therefore, the scope of the embodiment of this application shall depend on the scope of the claim.

What is claimed is:

1. A system of a tunable metasurface, wherein the system of the tunable metasurface comprises: a wavefront modulator, an optical focusing device, a metasurface;
the metasurface comprises a plurality of nanostructures made of a phase change material, and a phase change state of the phase change material comprises a crystalline state and an amorphous state;
the wavefront modulator is set on a side of the optical focusing device that is far away from the metasurface; and the wavefront modulator is configured to modulate a wavefront aberration of incident control lights and emit the control lights after wavefront modulated towards the optical focusing device;
the optical focusing device is configured to focus wavefront-modulated control lights to form a plurality of focal points;
the metasurface is set on a focal plane formed by the plurality of focal points, and at least some nanostructures correspond to positions of the plurality of focal points; the metasurface is configured to modulate a phase of an incident working light, and an optical path of the working light does not overlap with the wavefront modulator and the optical focusing device.

2. The system of the tunable metasurface according to claim 1, wherein the metasurface comprises a transparent substrate, and the plurality of nanostructures are set on one side of the transparent substrate;
one end of each nanostructure that is closer to the transparent substrate corresponds to the position of the focal point.

3. The system of the tunable metasurface according to claim 2, wherein the metasurface comprises a metal reflective layer;
the metal reflective layer is set between the nanostructures and the transparent substrate, and a side of the reflective layer that is closer to the nanostructures is a reflective side of the metal reflective layer.

4. The system of the tunable metasurface according to claim 3, wherein the wavefront modulator and the optical focusing device are set on a side of the metal reflective layer that is away from the nanostructures.

5. The system of the tunable metasurface according to claim 2, wherein the metasurface comprises a plurality of photo-thermal conversion structures;
the plurality of photo-thermal conversion structures are set on a side of the transparent substrate that is closer to the nanostructures, and the photo-thermal conversion structures are one-to-one corresponding with positions of the nanostructures;
the photo-thermal conversion structures are configured to convert a light energy of the incident control lights into thermal energy.

6. The system of the tunable metasurface according to claim 2, wherein the metasurface further comprises a matching dielectric layer;
the matching dielectric layer is set between the nanostructures and the transparent substrate, and the matching dielectric layer is contacted to the nanostructures.

7. The system of the tunable metasurface according to claim 2, wherein the metasurface further comprises a filler material, and the filler material is transparent at a working waveband;
and the filler material is filled between the nanostructures, and a difference between a refractive index of the filler material and a refractive index of the nanostructures is greater than or equal to 0.5.

8. The system of the tunable metasurface according to claim 1, wherein a numerical aperture of the optical focusing device is greater than a pre-set threshold;
when the numerical aperture of the optical focusing device is equal to the pre-set threshold, a size of the focal points of the optical focusing device formed on the metasurface is greater than or equal to a period of the nanostructures.

9. The system of the tunable metasurface according to claim 8, wherein the pre-set threshold is greater than or equal to 0.6.

10. The system of the tunable metasurface according to claim 1, wherein a wavefront aberration of the optical focusing device is less than 0.32, and A is a wavelength of the control lights.

11. The system of the tunable metasurface according to claim 1, wherein the optical focusing device comprises a lens group;
the lens group consists of a plurality of lenses.

12. The system of the tunable metasurface according to claim 11, wherein the lens group consists of at least one lens and at least one metalens.

13. The system of the tunable metasurface according to claim 11, wherein the lens group consists of a plurality of metalenses.

14. The system of the tunable metasurface according to claim 1, wherein the optical focusing device is an on-axis multi-focal focusing device.

15. The system of the tunable metasurface according to claim 1, wherein the optical focusing device is an off-axis multi-focal focusing device.

16. The system of the tunable metasurface according to claim 1, wherein a wavelength of the control lights is different from a wavelength of the working lights.

17. The system of the tunable metasurface according to claim 1, wherein the control lights are parallel lights.

18. The system of the tunable metasurface according to claim 1, wherein the phase change material comprises at least one material of germanium antimony telluride, germanium telluride, antimony telluride, and silver antimony telluride.

19. The system of the tunable metasurface according to claim 1, wherein the wavefront modulator is set on a position of an entrance pupil of the optical focusing device.

20. The system of the tunable metasurface according to claim 19, wherein a phase relationship between the positions of focal points of the optical focusing device and the position of the entrance pupil is as follows:
$$φ ( x , z ) = {\sum }_{i = 1} exp [ - ik ( {a}_{i} x + {b}_{i} z ) ]$$
wherein, x, z represent coordinate axes of the optical focusing device at a pupil plane, and a lowest value and a highest value of x, z are determined by an entrance pupil aperture of the optical focusing device; k is a wave number, and aᵢ and bᵢ are coordinates of the focal points on a iₜₕ focal plane.
